(19) United States
(12) Patent Application Publication
(10) Pub. No.: US 2012/0017149 A1
(43) Pub. Date: Jan. 19, 2012

(54) VIDEO WHISPER SESSIONS DURING ONLINE COLLABORATIVE COMPUTING SESSIONS

(76) Inventors: Jeffrey Lai, San Jose, CA (US); Huipin Zhang, Santa Clara, CA (US)

(21) Appl. No.: 12/837,042

(22) Filed: Jul. 15, 2010

(51) Int. Cl. G06F 3/01; G06F 17/00; G06F 15/16

(52) U.S. Cl. 715/716; 715/758; 700/94

(57) ABSTRACT

In one embodiment, a plurality of attendee devices may participate in an online collaborative computing session to receive video and audio content for the online collaborative computing session. A particular attendee device may then either initiate or receive a communicated signal between a “whisperer” and “whisperee” that indicates a desire of the whisperer to establish a video whisper session with the whisperee. In response, the video whisper session may be established between the whisperer and whisperee devices, such as through a mutual subscription by the whisperer and whisperee to a video channel and audio channel of each other corresponding device. In this manner, users of the whisperer and whisperee devices may see and hear each other via the video whisper session, and attendee devices other than the whisperer and whisperee are prevented from playing audio from the video whisper session between the whisperer and whisperee.

### TECHNICAL FIELD

The present disclosure relates generally to computer-based collaboration, and, more particularly, to online collaborative computing sessions.

### BACKGROUND

Assume that a physical meeting attendee is sitting in a conference room with a large attentive audience, while a speaker is giving a presentation with slide shows. If this attendee hears an acronym that he or she is unfamiliar with, and that is necessary to truly understand the speaker's presentation, the attendee may chose to interrupt the presentation to ask a question directly to the speaker, remain in silence without understanding the acronym, or may instead tap on the shoulder of another person sitting next to the attendee to whisper the question.

Online collaborative computing environments often imitate real-life scenarios. For example, various online collaborative computing sessions may include web meetings, video conferences, etc., where any number of attendees may be virtually present in an online session, such that the attendees receive material (e.g., an online slide show and accompanying audio) presented by a presenter. In the same manner as a physical meeting or conference, a virtually present attendee may have a question that he or she would rather not interrupt the entire presentation to ask.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example network device/node;

FIG. 3 illustrates an example display;

FIG. 4 illustrates an example exchange sequence between whisperer and whisperee devices;

FIG. 5 illustrates an example display;

FIGS. 6A and 6B illustrate example session flows; and

FIG. 7 illustrates an example procedure for video whisper sessions.

### DESCRIPTION OF EXAMPLE EMBODIMENTS

### Overview

According to embodiments of the disclosure, a plurality of attendee devices may participate in an online collaborative computing session to receive video and audio content for the online collaborative computing session. A particular attendee device may then either initiate or receive a communicated signal between a “whisperer” and “whisperee” that indicates a desire of the whisperer to establish a video whisper session with the whisperee. In response, the video whisper session may be established between the whisperer and whisperee devices, such as through a mutual subscription by the whisperer and whisperee to a video channel and audio channel of each other corresponding device. In this manner, users of the whisperer and whisperee devices may see and hear each other via the video whisper session, and attendee devices other than the whisperer and whisperee are prevented from playing audio from the video whisper session between the whisperer and whisperee.

### DESCRIPTION

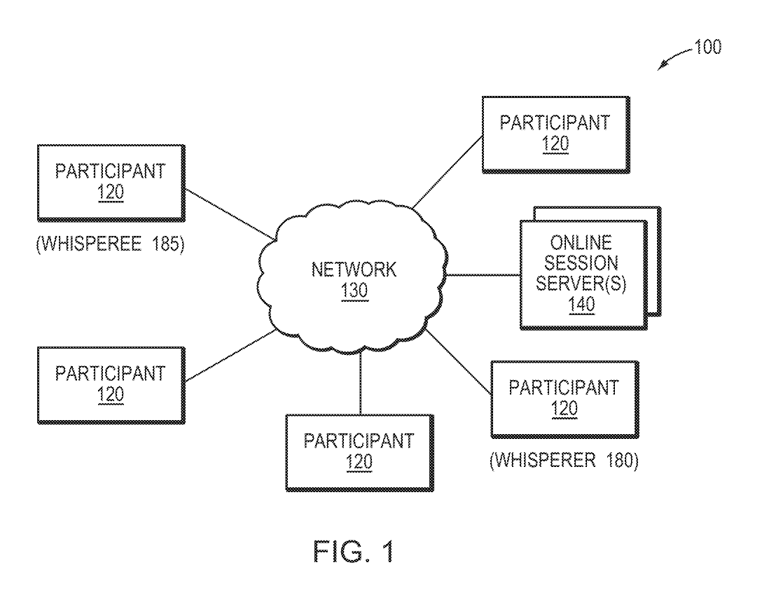

FIG. 1 is a schematic block diagram of an example computer network 100 illustratively comprising nodes/devices, such as one or more participant/client devices 120 (e.g., as “whisperer” 180 and “whisperee” 185 as described below) and one or more interaction servers 140 interconnected by links/network 130 as shown and as described further herein. For instance, participant devices, as described below, may be a personal computer (PC) or laptop, or one or more peripheral devices, such as phones, etc. Note that for illustrative purposes, certain participant devices may be located within a same room, or in physically distinct locations. Those skilled in the art will understand that any number of nodes, devices, links, etc. may be used in the computer network, and that the view shown herein is for simplicity.

In this environment, a number of participants may interact in an online, interactive, or collaborative setting. Such a setting can be for a meeting, training or education, support, or any other event that may require a number of participants to work together, interact, collaborate, or otherwise participate, such as web/video conferences, online meetings, etc. As used herein, the phrase “collaborative computing session” may be used to describe these settings/events, particularly where a number of participant computers/devices collaborate in an established session, as may be appreciated by those skilled in the art. Also, as used herein, a “session” describes a generally lasting communication between one or more participant devices 120 through the interaction server 140. Those skilled in the art will understand that the session may be implemented/established using protocols and services provided by various layers (e.g., application, session, and/or transport layers) of a network protocol stack according to the well-known OSI model. Conversely, a “meeting” describes a personal layer of communication overlaid upon the session where participants/users communicate with each other. Moreover, while the terms “session” and “meeting” may generally be used interchangeably herein to denote a collaboration of people or devices, particular instances of their use may denote a particular distinction (e.g., a session may start with attendees joining/connecting to the servers, while a meeting may not start until a host/presenter joins the session), as may be understood by those skilled in the art.

In particular, each participant (e.g., hosts/presenters and/or attendees) may operate a participant device. Each participant device (or client device, herein) 120 may comprise an electronic device with capability for visual and/or auditory presentation. Thus, a participant device can be, for example, a desktop personal computer (PC), a laptop computer, a workstation, a personal digital assistant (PDA), a wireless telephone, a smart phone, an Internet television, and the like. Each participant device 120 supports communication by a respective participant, in the form of suitable input device (e.g., keyboard, mouse, stylus, keypad, etc.) and output device (e.g., monitor, display, speech, voice, or other device supporting the presentation of audible/visual information). Each participant device may be interconnected with a suitable communications network 120 such as, for example, the Internet, and may appear as a client computer thereon.

In one embodiment, each participant device 120 may operate under the control of a suitable operating system (OS) (e.g., WINDOWS, UNIX, etc.) to run software applications (e.g., in the form of code modules) which may be installed, received, or downloaded. At least some of these software applications may support specific functions, such as, for example, functions related to the online, interactive meeting (a collaborative computing session), such as conventional web browser programs that allow convenient access and navigation of the Internet (e.g., the World Wide Web).

The online meeting (collaborative computing session) of the various participants may be supported by an interaction server 140 which may be maintained or operated by one or more of the participants and/or a third-party service provider. The interaction server 140 may be a computer system that is connected to network 130, and which may comprise and appear as one or more server computers thereon. Interaction server 140 may store information and/or content (e.g., audio, video, presentations, etc., such that the server is a source of the communication session), and application modules which can be provided to the participant devices 120. In some embodiments, the application modules are downloadable to the participant devices 120 and may support various functions that may be required for an interactive meeting or collaborative effort among the participants. The participant devices 120 and the interaction server 140 may interact in a client/server architecture, which may provide high performance and security for a multi-participant collaborative environment.

Network 130 may comprise or be supported by one or more suitable communication networks, such as, for example, a telecommunications network that allows communication via one or more telecommunications lines/channels. In particular, the communication or data networks, such as the Internet, may be used to deliver content, such as for the collaborative computing sessions herein. The Internet is an interconnection of computer clients and servers located throughout the world and exchanging information according to Transmission Control Protocol/Internet Protocol (TCP/IP), Internetwork Packet eXchange/Sequence Packet eXchange (IPX/SPX), AppleTalk, or other suitable protocol. The Internet supports the distributed application known as the “World Wide Web.” Web servers maintain websites, each comprising one or more web pages at which information is made available for viewing and audio/hearing. Each website or web page may be supported by documents formatted in any suitable is conventional markup language (e.g., HTML or XML). Information may be communicated from a web server to a client using a suitable protocol, such as, for example, Hypertext Transfer Protocol (HTTP) or File Transfer Protocol (FTP).

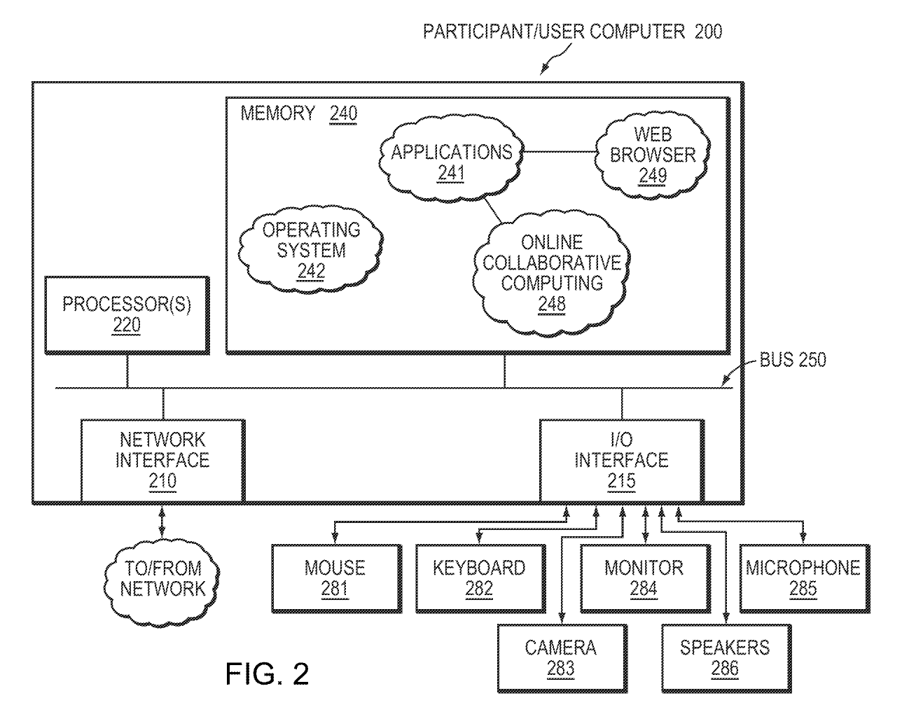

FIG. 2 illustrates a schematic block diagram of an example participant/client device 200 (e.g., 120) that may be used with one or more embodiments described herein, e.g., for collaborative computing as participant/client devices. Illustratively, device 200 may be implemented or incorporated in any suitable computer such as, for example, a personal computer (PC), laptop, workstation, personal digital assistant (PDA), smart phone, mainframe, file server, workstation, or other suitable data processing facility supported by storage (either internal, e.g., electronic memory, or external, e.g., magnetic/optical disk), and operating under the control of any suitable OS.

In particular, the device 200 may comprise one or more network interfaces 210, one or more input/output (I/O) interfaces 215, one or more processors 220, and a memory 240 interconnected by a system bus 250. The network interfaces 210 contain the mechanical, electrical, and signaling circuitry for communicating data over physical/wireless links coupled to the network 130. The network interface(s) may be configured to transmit and/or receive data using a variety of different communication protocols suitable for the network (e.g., wired or wireless). Also, I/O interfaces 215 contain the mechanical, electrical, and signaling circuitry for communicating with one or more user interface devices, such as a mouse 281, a keyboard 282, a video input (e.g., a camera) 283, a video output (e.g., monitor/screen) 284, an audio input (e.g., microphone) 285, and an audio output (e.g., speakers) 286.

The memory 240 comprises a plurality of storage locations that are addressable by the processor(s) 220 for storing software programs associated with the embodiments described herein. A portion of the memory may (though need not) be arranged as a cache configured to store one or more data structures and/or code modules associated with embodiments described herein. The processor(s) 220 may comprise necessary elements or logic adapted to execute the software programs and manipulate the data structures. An operating system 242, portions of which are typically resident in memory 240 and is executed by the processor(s), functionally organizes the device by, inter alia, invoking operations in support of software processes and/or services executing on the device (e.g., for collaborative computing sessions as used herein). In particular, these software processes and/or services may comprise one or more applications 241 or “apps,” such as email, web browsers 249 (e.g., Microsoft Internet Explorer, Mozilla Firefox, etc.), schedule management applications (e.g., Microsoft Outlook, Lotus Notes, etc.), games, and so on, and, in particular, an online collaborative computing process 248, as described herein. It will be apparent to those skilled in the art that other types of processors and memory, including various computer-readable media, may be used to store and execute program instructions pertaining to the technique described herein.

The online collaborative computing process 248 may contain computer executable instructions executed by the processor 220 to generally perform functions to manage or control various processes or aspects during the course of an online meeting or collaborative computing session in which the participant (user) may interact with other users. For instance, an activity manager may manage meeting-related actions (e.g., starting a session, ending a session, locking a session, etc.), manage participant-related actions (e.g., designating a participant as a session host, assigning a participant the presenter privileges, expelling a participant, establishing participant privileges, etc.), manage session-related actions (e.g., starting a sharing session, closing a sharing session, setting privileges within that sharing session, etc.), and support an interface with the user or participant, and provide a container for embedding one or more application code modules. Generally, online collaborative computing process may interact with web browser 249 to result in end-user experience.

Also, a communications component of process 248 may support communication between system 200 and an outside network 130 (e.g., the Internet), such as through network interfaces 210. The communications component thus allows data and information to be exchanged with or retrieved from other systems or facilities (e.g., participant devices 200 or interaction server 140), for example, during an online meeting or other collaborative computing session. In particular, the communications component may provide a communication platform for any one or more process instances of process 248. For instance, the activity manager may rely on the communications component to establish and maintain the client connection to the interaction server 140 on which the activity session is hosted. Any application code modules (not shown) may also use the established client connection to provide real-time data that is sent and received by each participant.

Various functionality for supporting a collaborative computing session, such as an online meeting, may be provided by the one or more application code modules, generally described herein as being components of the online collaborative computing process 248. These application code modules may be stored/maintained (e.g., by a cache), and may support, for example, basic communication framework, file sharing (e.g., for text, images, video, audio), remote access, user authentication, meeting scheduling, address book, files and folders, invoices, billing, scheduling, telephone or video conferencing, authentication, database management, word processing, application sharing, accounting, etc. For example, code modules may comprise (not specifically shown) a text-based chat module, a polling module, a video module, a voice over Internet Protocol (VOIP) module, a question-answer (QA) module, a file transfer module, a presentation module, an application/desktop view/share module, and an Internet telephony module.

In addition, it should be noted that the example implementation for a computer system (device 200) may also operate as an interaction server 140 according to one or more embodiments described herein. In particular, online collaborative computing process may be configured on a server 140 to functionally manage one or more online collaborative computing sessions, such as providing website access, meeting or conference support, database management, communication support, etc. Notably, according to one or more embodiments described herein, an online collaborative computing session may comprise one or more “sub-sessions,” such as a different sub-session for various components or features of the session itself. For instance, these sub-sessions may comprise, e.g., voice, data, desktop sharing, document sharing (portable document), video, chat, file transfer, remote access, etc. Communication and/or collaboration between participants may thus be achieved with one or more of the above sub-sessions enabled, e.g., generally via an interaction server 140. Also, while an illustrative embodiment described utilizes a single interaction server 140, a collection of servers (e.g., localized and/or distributed) may also operate to perform the functions described herein.

As noted above, online collaborative computing environments often imitate real-life scenarios, such as meetings, conferences, training sessions, etc., where any number of attendees may be present to receive material presented by a presenter. In the case of online environments, the meetings are virtual (e.g., web-based), and the material is delivered as content over one or more communication sessions, such as data, audio, video, etc. Just as would be found in a physical setting, a meeting attendee may have a question that he or she would rather not interrupt the entire presentation to ask, or may have a comment for another attendee that would be better kept private between the two attendees.

Current online collaboration programs typically include a side “chat” feature, where attendees may send instant messages or “IMs” to other attendees. For instance, an instant text message application may be provided that allows participants to chat in text to one or all participants. That is, using text-based chat, participants can easily communicate with each other without having to interrupt the presenter or any ongoing conversations between other participants. However, typing into chat boxes may not be particularly time efficient for certain users, and may not offer the attendees a rich collaboration environment.

According to embodiments of the disclosure, a video “whisper” session may be provided to attendees within an online collaborative computing session, such that a “whisperer” 180 and “whisperee” 185 (participants/devices 120/200) may communicate in a side/private video conference during an ongoing online collaboration session. For example, to engage in a whisper session, which is described more fully below, a first user (whisperer) may select another user (whisperee) to receive a “shoulder tap” message. The selected user may then respond by accepting or declining the video whisper invitation. Once accepted, the whisperer and whisperee may engage in private video conversation, while any background audio such as conversations between other participants may be reduced, and the private conversation is not heard by other attendees of the online collaborative computing session.

Illustratively, the techniques described herein may be performed by hardware, software, and/or firmware, such as in accordance with online collaborative computing process 248, which may contain computer executable instructions executed by the processor 220 to perform functions relating to the novel techniques described herein, e.g., in conjunction with any processes or drivers in use to operate corresponding I/O devices, (e.g., 281-286). For instance, either the whisperer or whisperee or both may be participating in an online collaborative computing session as a particular attendee device of a plurality of attendee devices that receive video and audio content for the online collaborative computing session, through process 248. Moreover, the techniques herein may be implemented at the whisperer and whisperee devices (e.g., in certain embodiments with configuration at other attendee devices 120), and the server 140 need not be utilized in one or more embodiments.

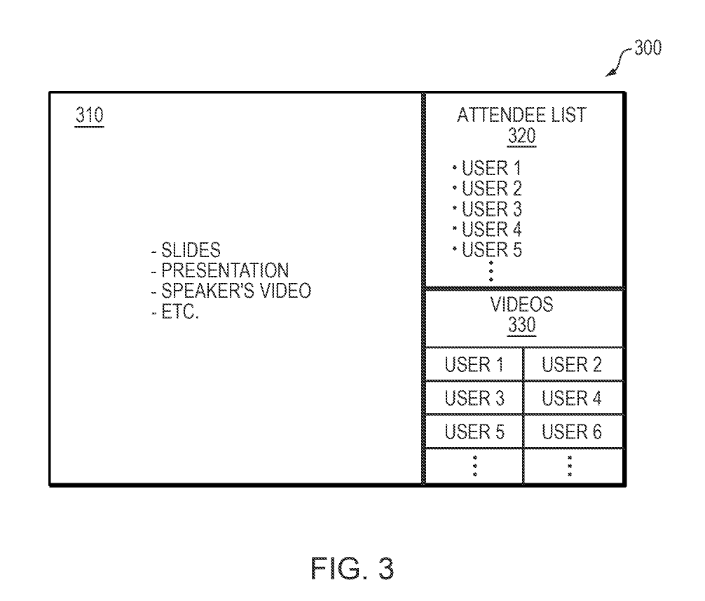

FIG. 3 illustrates an example display layout of an online collaborative computing session 300, which may comprise a portion 310 for slides or presentation materials, a list of attendees 320, and one or more video images 330 of other attendees to the online collaborative computing session. Those skilled in the art will appreciate that this view is merely a representative example, and not meant to limit the scope of the embodiments herein.

Operationally, to initiate a video whisper session, a whisperer may select a whisperee with whom to have a video whisper session. For instance, a whisperer device 180/200 (also simply referred to as the “whisperer”) may determine a selection of the whisperee from a visual display 300, such as a display indicating one or more attendee devices of the online collaborative computing session. For example, this may be implemented by clicking on a whisperee's name in list 320, the whisperee's video from the set of videos 330, typing in the whisperee's name or identification into a prompt, etc., and selecting a video whisper option (e.g., from a drop down menu, a “right-click” option list, etc.). A “shoulder tap” signal may then be sent from the whisperer device to the appropriate whisperee device 185/200 (also simply referred to as the “whisperee”).

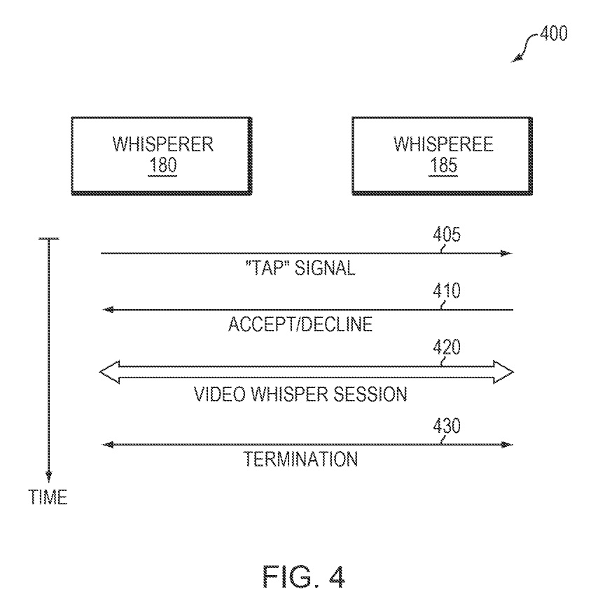

FIG. 4 illustrates an example exchange sequence 400 between whisperer and whisperee devices, beginning with a “tap” signal 405 that is any communication from the whisperer to the whisperee that indicates a desire of the whisperer to establish a video whisper session with the whisperee. The whisperee may receive the communicated signal 405, and may respond with another signal 410 that either accepts or declines the video whisper invitation. Once accepted, a direct video whisper (private chat) session 420 is established between the whisperer and whisperee.

Specifically, the video whisper session established and maintained for both whisper parties generally comprises a mutual subscription by the whisperer and whisperee to a video channel and audio channel of each other corresponding device. In this manner, users of the whisperer and whisperee devices may see and hear each other via the video whisper session. In addition, attendee devices other than the whisperer and whisperee are prevented at least from playing audio from the video whisper session between the whisperer and whisperee, and in one or more embodiments also prevented from seeing the video of the whisper session. Further, in accordance with one or more embodiments herein, to enhance the experience of a video whisper session, the volume of any background audio content for the online collaborative computing session (or otherwise), such as conversations between other participants, may be reduced or completely muted for the two whisper parties.

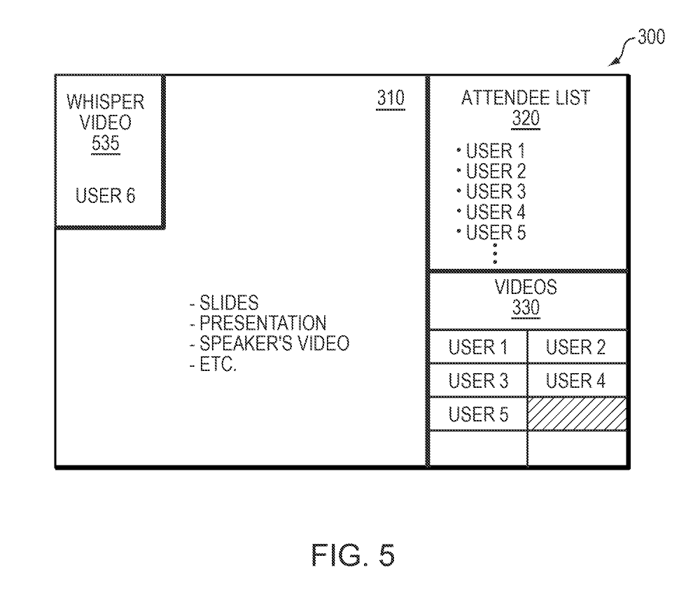

FIG. 5 illustrates the example display 300 showing a new video window 535 that shows the corresponding whisperee or whisperer (depending upon which device is showing the display 300). For example, through the video subscription to each other's video streams, a new video window may pop up to show the whisper videos in a variety of configurable manners. For instance, each device may receive and display the subscribed video channel on a display 284 of the corresponding device in an orientation such as: a picture-in-picture (PiP) window of the subscribed video channel within a window of the online collaborative computing session video (e.g., as shown 535); a head-to-head window of the subscribed video channel in place of the window of the online collaborative computing session video (e.g., all of portion 310); and a pop-up window of the subscribed video channel (e.g., a new window separate from the existing session display). Other arrangements are available to embodiments herein, such as having both the whisperer and whisperee appear in a single window (i.e., such that each user also sees themselves).

Additionally, the whisper session parties (whisperer and whisperee) also subscribe to each other's audio. Further to that, however, according to one or more embodiments herein the whisper audio channel may be controlled so that attendees outside the video whisper session do not hear any of the whisper content. This can be achieved through a variety of prevention mechanisms, and may be controlled on the whisperer/whisperee devices 200, the server 140, or other attendees 120. In particular, attendee devices other than the whisperer and whisperee may be prevented from playing audio from the video whisper session through transmitting the audio from the video whisper session on an audio channel directly between the whisperer and whisperee (i.e., not through the server 140), or transmitting the audio to the server and having the server drop it during the audio transmission. Alternatively, the audio may be transmitted on an audio channel of the online collaborative computing session that is transiently created between the whisperer and whisperee for the video whisper session; that is, through the server, but specifically dedicated to the private conversation of the whisper session. As an additional alternative, audio from the video whisper session received on an audio channel of the online collaborative computing session by an attendee device other than the whisperer and whisperee may simply be muted by those devices.

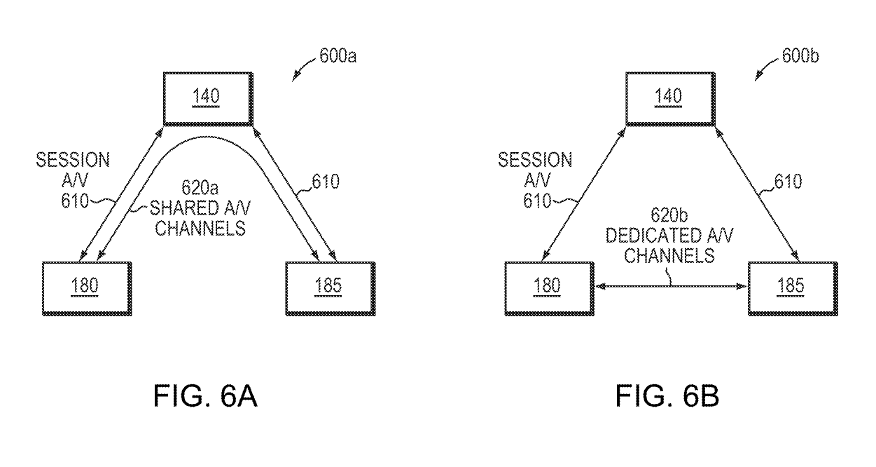

FIGS. 6A and 6B illustrate example session flows 600a/b that may either be directed through server 140 (6A) or directly between video whisper session parties (6B). For instance, in FIG. 6A, the online collaborative computing session comprises audio and video (A/V) channels (or streams) 610 to and from each participant, and the A/V channels 620a for the video whisper session utilize the same channels. In particular, in one or more embodiments, a whisper party need not manually request for the other party's video before the whisper session starts, since the existing video channel may be is used for the whisper session. Similarly, the whisper audio may be enabled between the two whisper parties using an existing audio channel. Alternatively, in FIG. 6B, A/V channels 620b for the video whisper session are dedicated streams between the participating devices 200.

According to one or more alternative embodiments, the whisperee may only accept sharing of the whisperee's audio channel during the video whisper session, at which time the session may become an audio conference only, or the whisperer's video may continue to be sent to the whisperee. Further, for various purposes, the video whisper session may consist solely of video channel communication, such that private audio is not distributed between the whisperer and whisperee.

Notably, to respect the privacy of whisper parties, one or more embodiments herein may prevent whisper audio and video from being recorded by a meeting recorder. Also, if a video image from at least one of the whisperer and whisperee is displayed within the online collaborative computing session prior to establishing the video whisper session (e.g., box 330), then in response to establishing the video whisper session, attendee devices other than the whisperer and whisperee may further be prevented from displaying video from the video whisper session. For example, the corresponding video in box 330 may be blacked out, frozen, or removed temporarily during the video whisper session.

Conversely, due to respect of the presenter, one or more embodiments may be configured to limit each video whisper session to two attendee devices. Other attendees may establish other video whisper sessions, but each session may be limited to a certain number of attendees. Further, video whisper sessions may be limited by a specified time limit, which may be a default configuration, or adjustable by the presenter or host of the online collaborative computing session. The host or presenter may also have the ability to terminate the video whisper sessions, or toggle whether they are allowed during the presentation at all. For instance, it may be displayed within the online collaborative computing session display 300, at least to the presenter or host, whether certain attendees have established a video whisper session (e.g., particularly for school use). At the same time, however, to respect the privacy of the whisperer and whisperee, it may also be beneficial to not include this feature.

A video whisper session may be terminated by either whisper party (e.g., by closing the video whisper session window 535), and in response, any original settings of the video and audio of the online collaborative computing session may be restored at the whisperer and whisperee devices. For instance, any dedicated video windows may be closed, all background audios may return to normal volume, and both whisper parties' audio may again become audible to all meeting attendees. If the video was also privatized for the whisper session, that video may also be visible to all attendees, as well. Illustratively, once one whisper party terminates the whisper session, the other whisper party's video window may be automatically closed, or the other whisper party may at least be notified of the termination.

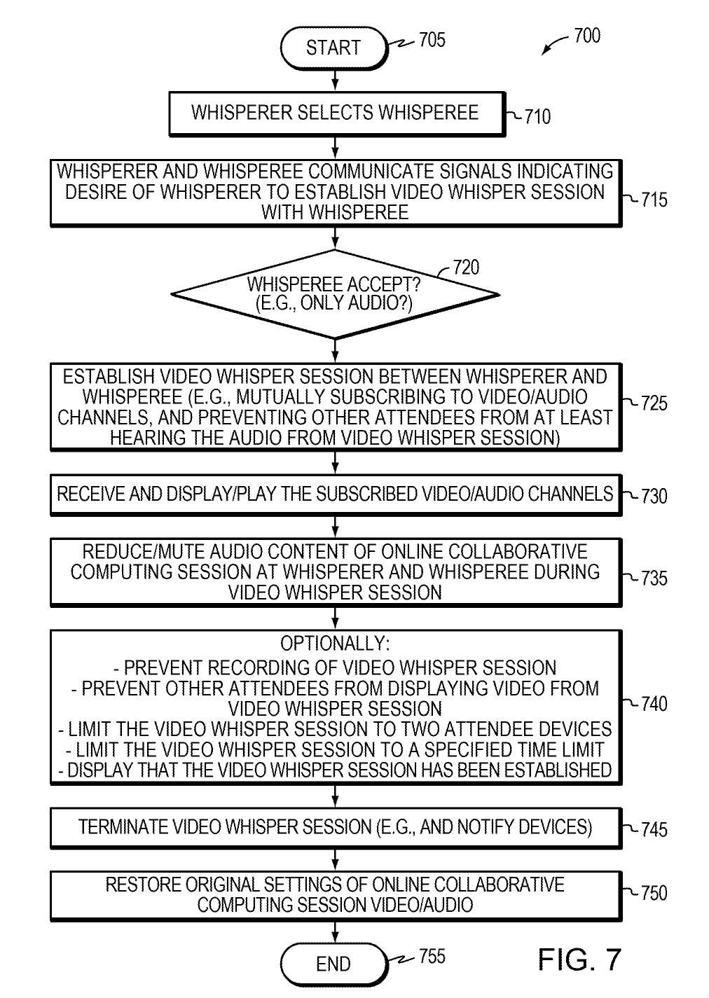

FIG. 7 illustrates an example simplified procedure for video whisper sessions in accordance with one or more embodiments described herein. The procedure 700 starts at step 705 (e.g., during an ongoing online collaborative computing session), and continues to step 710, where a whisperer 180 selects a whisperee 185, such as from a list of attendees of the online collaborative computing session. Accordingly, in step 715, the whisperer and whisperee communicate signals (e.g., tap signals 405) indicating the desire of the whisperer to establish a video whisper session with the whisperee. If the whisperee accepts in step 720, e.g., sending an acceptance 410 to the whisperer, then the procedure continues to step 725 where the video whisper session is established between the whisperer and whisperee. For instance, the whisperer and whisperee may mutually subscribe to video/audio channels of each other (e.g., 620), and other attendees may be prevented from at least hearing the audio from video whisper session, while in one or more embodiments also being prevented from seeing the video of the whisper session. Notably, as mentioned herein, the acceptance 410 in step 720 may indicate an interest to keep the video whisper session to an audio-only session, i.e., preventing the video stream between the whisperer and whisperer in at least one direction.

During the established video whisper session, content from the subscribed is video/audio channels may be received and displayed/played in step 730, while (optionally) reducing or muting the audio content of the online collaborative computing session at the whisperer and whisperee in step 735. Further options of the video whisper session, as noted above, may take place in step 740, such as: preventing recording of the video whisper session; preventing other attendees from displaying video from the video whisper session; limiting the video whisper session to two attendee devices; limiting the video whisper session to a specified time limit; and displaying that the video whisper session has been established.

The video whisper session may continue until its termination in step 745, such as when either the whisperer or whisperee decides to end the session (or after a time limit). In one embodiment, one or both of the whisperer and whisperee may be notified of the termination, informing the users that they are no longer in a private video session. Particularly, in step 750 the original settings of the online collaborative computing session video/audio may be restored at the whisperer and whisperee devices, and the procedure 700 for video whisper sessions ends in step 755, until another video whisper session is requested.

The novel techniques described herein provide for a video whisper session functionality within an online collaborative computing environment. The video whisper feature provides an instant idea exchange using an audio/video channel without having to interrupt the central ongoing presentation, thus enhancing the user experience of meeting participants and presenters. The video whisper allows participants to discuss questions or comments privately through video while at the same time listening to an ongoing presentation being conducted by the presenter. Talking to others and receiving feedback through a private or “side” video discussion may create a richer collaboration environment and may possibly be more time efficient to than typing into chat boxes. In addition, to simulate physical meeting or conference room scenarios, certain measures are described, such as allowing only two participants per whisper or setting a time limit for each talk.

While there have been shown and described illustrative embodiments that provide for a video whisper session functionality within an online collaborative computing environment, it is to be understood that various other adaptations and modifications may be made within the spirit and scope of the embodiments herein. For example, the embodiments have been shown and described herein for use when a video conference attendee wishes to initiate a private video chat during an ongoing multi-party conference session. In particular, the embodiments in their broader sense are not limited to merely web meetings or video conferences, but may, in fact, be used with telepresence sessions, video over Internet Protocol (IP) sessions, broadcast sessions (receiving broadcast video content), and multicast sessions (receiving multicast video content).

Further, while it shown that the whisperer and whisperee are both attendees/participants in the online collaborative computing session, the embodiments herein may also be applicable to situations where the corresponding other whisperee or whisperer is not an attendee device in the online collaborative computing session. For instance, the video whisper session may be between a whisperer of the online collaborative computing session and a whisperee merely through a separate video channel, or alternatively, the whisperer may tap a whisperee that is currently a participant in an online collaborative computing session. Thus, the embodiments herein may be used by any video conferencing programs, and not simply multi-party video conferencing programs, so long as at least one of the video whisper users is within a multi-party video conference at the time.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible computer-readable medium (e.g., disks/CDs/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
participating in an online collaborative computing session as a particular attendee device of a plurality of attendee devices that receive video and audio content for the online collaborative computing session;
communicating, at the particular attendee device as one of either an initiating whisperer or a receiving whisperee, a signal between the whisperer and whisperee indicating a desire of the whisperer to establish a video whisper session with the whisperee; and, in response,
establishing the video whisper session between the whisperer and whisperee devices, the video whisper session established through a mutual subscription by the whisperer and whisperee to a video channel and audio channel of each other corresponding device, such that users of the whisperer and whisperee devices may see and hear each other via the video whisper session, and wherein attendee devices other than the whisperer and whisperee are prevented from playing audio from the video whisper session between the whisperer and whisperee.

2. The method as in claim 1, further comprising:
reducing a volume of the audio content for the online collaborative computing session at the whisperer and whisperee during the video whisper session.

3. The method as in claim 2, further comprising:
muting the volume.

4. The method as in claim 1, further comprising:
accepting, by the whisperee, the video whisper session.

5. The method as in claim 4, further comprising:
accepting, by the whisperee, only to share the audio channel of the whisperee during the video whisper session.

6. The method as in claim 1, further comprising:
terminating the video whisper session; and, in response,
restoring original settings of the video and audio of the online collaborative computing session at the whisperer and whisperee.

7. The method as in claim 6, wherein the terminating is performed by one of the whisperer or whisperee, the method further comprising:
notifying at least the other of the whisperer and whisperee of the termination.

8. The method as in claim 1, further comprising:
determining, by the whisperer, a selection of the whisperee from a visual display indicating one or more attendee devices of the online collaborative computing session.

9. The method as in claim 1, further comprising:
receiving and displaying the subscribed video channel on a display of the corresponding device in an orientation selected from a group consisting of: a picture-in-picture (PiP) window of the subscribed video channel within a window of the online collaborative computing session video; a head-to-head window of the subscribed video channel in place of the window of the online collaborative computing session video; and a pop-up window of the subscribed video channel.

10. The method as in claim 1, further comprising:
preventing attendee devices other than the whisperer and whisperee from playing audio from the video whisper session between the whisperer and whisperee through a prevention mechanism selected from a group consisting of: transmitting the audio from the video whisper session on an audio channel directly between the whisperer and whisperee; transmitting the audio from the video whisper session on an audio channel of the online collaborative computing session that is transiently created between the whisperer and whisperee for the video whisper session; and muting audio from the video whisper session received on an audio channel of the online collaborative computing session by an attendee device other than the whisperer and whisperee.

11. The method as in claim 1, further comprising:
limiting the video whisper session to two attendee devices.

12. The method as in claim 1, further comprising:
limiting the video whisper session to a specified time limit.

13. The method as in claim 1, further comprising:
preventing recording of the video whisper session.

14. The method as in claim 1, further comprising:
displaying to at least a presenter device of the online collaborative computing session that the video whisper session has been established.

15. The method as in claim 1, wherein the video channel and audio channel of the whisperer and whisperee for the video whisper session are used for the online collaborative computing session prior to establishing the video whisper session.

16. The method as in claim 1, further comprising:
displaying a video image from at least one of the whisperer and whisperee within the online collaborative computing session prior to establishing the video whisper session; and
in response to establishing the video whisper session, preventing attendee devices other than the whisperer and whisperee from displaying video from the video whisper session between the whisperer and whisperee.

17. The method as in claim 1, wherein the online collaborative computing session is selected from a group consisting of: a web meeting; a video conference; a telepresence session; a video over Internet Protocol (IP) session; a broadcast session; and a multicast session.

18. The method as in claim 1, wherein the particular attendee device is one of either the whisperer or whisperee, and wherein the corresponding other whisperee or whisperer is not an attendee device in the online collaborative computing session.

19. A tangible computer-readable media having software encoded thereon, the software when executed on a particular attendee device operable to:
participate in an online collaborative computing session with a plurality of attendee devices that receive video and audio content for the online collaborative computing session;
communicate, as one of either an initiating whisperer or a receiving whisperee, a signal between the whisperer and whisperee indicating a desire of the whisperer to establish a video whisper session with the whisperee; and, in response,
establish the video whisper session between the whisperer and whisperee devices, the video whisper session established through a mutual subscription by the whisperer and whisperee to a video channel and audio channel of each other corresponding device, such that users of the whisperer and whisperee devices may see and hear each other via the video whisper session, and wherein attendee devices other than the whisperer and whisperee are prevented from playing audio from the video whisper session between the whisperer and whisperee.

20. The tangible computer-readable media as in claim 19, wherein the software when executed is further operable to:
reduce a volume of the audio content for the online collaborative computing session during the video whisper session.

21. The tangible computer-readable media as in claim 19, wherein the particular attendee device is one of either the whisperer or whisperee, and wherein the corresponding other whisperee or whisperer is not an attendee device in the online collaborative computing session.

22. An apparatus, comprising:
a processor;
a video input;
a video output;
an audio input;
an audio output;
means for participating in an online collaborative computing session with a plurality of attendee devices that receive video and audio content for the online collaborative computing session;
means for communicating, as one of either an initiating whisperer or a receiving whisperee, a signal between the whisperer and whisperee indicating a desire of the whisperer to establish a video whisper session with the whisperee; and
means for establishing the video whisper session between the whisperer and whisperee devices, the video whisper session established through a mutual subscription by the whisperer and whisperee to a video channel and audio channel of each other corresponding device, such that users of the whisperer and whisperee devices may see and hear each other via the video whisper session, and wherein attendee devices other than the whisperer and whisperee are prevented from playing audio from the video whisper session between the whisperer and whisperee.

23. The apparatus as in claim 22, further comprising:
means for reducing a volume of the audio content for the online collaborative computing session during the video whisper session.

24. The apparatus as in claim 22, wherein the apparatus is one of either the whisperer or whisperee, and wherein the corresponding other whisperee or whisperer is not an attendee device in the online collaborative computing session.
